(19) United States
(12) Patent Application Publication
(10) Pub. No.: US 2013/0148327 A1
(43) Pub. Date: Jun. 13, 2013

(54) ILLUMINATING KEYBOARD

(71) Applicant: BIN-HUI HUANG, Taipei (TW)

(72) Inventor: BIN-HUI HUANG, Taipei (TW)

(73) Assignee: Primax Electronics Ltd., Taipei (TW)

(21) Appl. No.: 13/567,479

(22) Filed: Aug. 6, 2012

(30) Foreign Application Priority Data
Dec. 9, 2011 (TW) 100145599

(51) Int. Cl. G01D 11/28

(52) U.S. Cl. 362/23.03

(57) ABSTRACT

The present invention discloses an illuminating keyboard including a plurality of keys, a membrane switch circuit, a reflector plate, at least one light source and a main circuit board. The reflector plate includes a light source conducting circuit connected with the membrane switch circuit that is connected with the main circuit board. The reflector plate is arranged under the membrane switch circuit, and the at least one light source is arranged on the reflector plate and connected with the light source conducting circuit, such that the main circuit board transfers an electricity to the at least one light source through the membrane switch circuit and the light source conducting circuit.

### FIELD OF THE INVENTION

The present invention generally relates to a keyboard, and more particularly to a keyboard capable of illuminating.

### BACKGROUND OF THE INVENTION

The keyboard is a kind of commonly used computer peripheral devices capable of inputting letters or commands to a computer. FIG. 1 illustrates an external structural view of a conventional keyboard. Referring to FIG. 1, there are a plurality of keys 10 located on a surface of the conventional keyboard 1, those keys 10 are categorized into common keys 101, number keys 102, function keys 103 and so on, and a user can press down any one of the keys by using his finger, so as to generate a corresponding signal to a computer and thus enable the computer to execute a key function corresponding to the key being pressed down. For example, the common keys 101 can be used for keying in symbols such as English letters, the number keys 102 can be used for keying in numbers, while the function keys 103 can be used for executing various functions such as F1 to F12 and so on.

With the evolution of technology, the keyboard manufacturers attend to developing various keyboards with specific functions in order to meet various demands from different users, for example an illuminating keyboard with illuminating function. An appearance of a conventional illuminating keyboard is substantially the same as an appearance of a conventional keyboard 1. However, the illuminating keyboard is capable of providing a function of illuminating the keys thereof, and thus an internal structure thereof is different from an internal structure of the conventional keyboard incapable of illuminating. For illustration, an internal structure of a conventional illuminating keyboard is illustrated as below. FIG. 2 illustrates a structural cross-sectional view of a conventional illuminating keyboard. Referring to FIG. 2, the conventional illuminating keyboard 2 comprises a plurality of keys 20, a membrane switch circuit 21, a light guide plate 22, a light emitting module 23, a main circuit board 24, a reflector plate 25 and a base 26. Each one of the keys 20 comprises a key cap 201, a key housing 202 and an elastomer 203. An arranging sequence of the foregoing components in the conventional illuminating keyboard 2 from top to bottom is the key caps 201, the key housings 202, the elastomers 203, the membrane switch circuit 21, the light guide plate 22, the reflector plate 25 and the base 26. The main circuit 24 is located at a side of the membrane switch circuit 21 and connected with the membrane switch circuit 21 and capable of providing an electricity to the membrane switch circuit 21, while the light emitting module 23 is located at an another side of the membrane switch circuit 21, and the light emitting module 23 is connected with the main circuit board 24 via an electric wire (not shown in figures), so as to obtain the electricity coming from the main circuit board 24.

In each one of the keys 20, the key cap 201 is exposed outside the conventional illuminating keyboard 2 and thus capable of being pressed down by a user. The key housing 202 is capable of holding the key cap 201 and the elastomer 203, while the elastomer 203 passes through the key housing 202 and respectively contacts with the key cap 201 and the membrane switch circuit 21. The membrane switch circuit 21 comprises an upper circuit board 211, an insulating layer 212 and a lower circuit board 213, wherein all of the circuit board 211, the insulating layer 212 and the lower circuit board 213 are made of transparent material, and the transparent material is Polycarbonate (PC) or Polyethylene Terephthalate (PET) and so on. The upper circuit board 211 has a plurality of upper contacts 2111. In addition, the insulating layer 212 is located under the upper circuit board 211 and has a plurality of insulating layer apertures 2121 corresponding to the plurality of upper contacts 2111. Besides, a lower circuit board 213 is located under the insulating layer 212 and has a plurality of lower contacts 2131 corresponding to the plurality of upper contacts 2111 and forming a plurality of key contacts with the plurality of upper contacts 2111. The membrane switch circuit 21 is capable of transferring signals to the main circuit board 24 since it connects with the main circuit board 24.

As shown in FIG. 2, the light emitting module 23 comprises an illuminating circuit board 231 and a plurality of light sources 232 (only one light source 232 is shown in the figure). The illuminating circuit board 231 is located at another side of the membrane switch circuit 21 and capable of transferring the electricity provided according to the main circuit board 24 to the plurality of light sources 232. Furthermore, the plurality of light sources 232 are arranged on the illuminating circuit board 231 and obtain the electricity, so as to generate a plurality of light beams. Herein, the plurality of light sources 232 are arranged in a row (not shown in the figure). However, the plurality of light sources 232 are not limited to be arranged regularly, but the locations of the plurality of light sources 232 are capable of being adjusted according to the illumination result of the illuminating keyboard 2 to form an irregular arrangement, so as to form the light emitting module 23 as a light bar. In addition, the light guide plate 22 has a plurality of light guide regions 221, and the light guide regions 221 are capable of guiding the plurality of light beams, so as to enable the plurality of light beams to be projected to the key caps 201. The reflector plate 25 of the conventional illuminating keyboard 2 is located under the light guide plate 22 and capable of reflecting the plurality of light beams, so as to prevent a light amount of the light beams from being wasted. Moreover, the base 26 is located under the reflector plate 25 and capable of carrying the key caps 201, the key housings 202, the elastomers 203, the membrane switch circuit 21, the light guide plate 22 and the reflector plate 25.

Further, in the conventional illuminating keyboard 2, there is a light transmissive region 2011 on each one of the key caps 201, and the light transmissive regions 2011 are the locations of the letters or the symbols, wherein the locations of the light transmissive regions 2011 correspond to the light guide regions 221 on the light guide plate 22, and thus the light beams are capable of being guided to the light transmissive regions 2011 thereof via the dot patterns 2211 of the light guide regions 221. As a result, an illumination result is capable of being provided to the letters or the symbols on the key caps 201 because the light beams are capable of being transmitted therethrough.

It should be noted that, in the conventional illuminating keyboard 2, both of the electricity of the membrane switch circuit 21 and the light emitting module 23 thereof are provided by the main circuit board 24. However, the main circuit board 24 is located at a side of the membrane switch circuit 21, but the light emitting module 23 is located at the other side of the membrane switch circuit 21. As a result, the assembly procedure of the conventional illuminating keyboard 2 is complicated because the illuminating circuit board 231 of the light emitting module 23 can be connected with the main circuit board 24 only by circuit layout. In addition, it is likely to occur a wrapped or an uneven assembly result of the illuminating circuit board 231 during the assembly procedure thereof. As a result, the plurality of light beams generated by the plurality of light sources 232 are unable to be uniformly projected into the light guide plate 22, so that an illumination result provided by the conventional illuminating keyboard 2 is uniform.

### SUMMARY OF THE INVENTION

The present invention is directed to providing an illuminating keyboard, wherein an assembly procedure of the illuminating keyboard is capable of being simplified.

The present invention is further directed to providing an illuminating keyboard with a uniform illumination result.

In a preferred embodiment, the present invention provides an illuminating keyboard comprising:
a plurality of keys;
a membrane switch circuit, having a plurality of key contacts, and each one of the key contacts corresponding to one of the keys;
a reflector plate, located under the membrane switch circuit, and the reflector plate comprising a light source conducting circuit, wherein the light source conducting circuit is capable of transferring an electricity; and
at least one light source, arranged on the reflector plate, connected with the light source conducting circuit, and capable of generating at least one light beam according to the electricity.

In a preferred embodiment, the light source conducting circuit is arranged on an upper surface or a lower surface of the reflector plate, while the at least one light source is arranged on the upper surface or the lower surface of the reflector plate and located at a side of the membrane switch circuit.

In a preferred embodiment, the reflector plate is made of an opaque PET.

In a preferred embodiment, the reflector plate further comprises a reflective ink arranged on an upper surface of the reflector plate, so as to enable the reflector plate to reflect the at least one light beam, and the reflector plate is made of a transparent PET.

In a preferred embodiment, the illuminating keyboard of the present invention further comprises a main circuit board connected with the membrane switch circuit and capable of providing the electricity to the membrane switch circuit and the light source conducting circuit.

In a preferred embodiment, the light source conducting circuit further comprises a first bonding region, while the membrane switch circuit comprises:
a bus, connected with the main circuit board and capable of transferring the electricity or a plurality of signals corresponding to the plurality of key contacts; and
a conducting circuit, connected with the plurality of key contacts and the bus, and the conducting circuit has a second bonding region capable of connecting with the first bonding region of the light source conducting circuit and transferring the electricity coming from the main circuit board to the light source conducting circuit.

In a preferred embodiment, the reflector plate further comprises a reflector plate bus, a first end of the reflector plate bus is connected with the light source conducting circuit, and a second end of the reflector plate bus is connected with the main circuit board and capable of transferring the electricity coming from the main circuit board to the light source conducting circuit.

In a preferred embodiment, the membrane switch circuit further comprises:
an upper circuit board, having at least one contact;
an insulating layer, located under the upper circuit board, the insulating layer having at least one insulating layer aperture corresponding to the at least one upper contact, and the at least one upper contact capable of inserting into the at least one insulating layer aperture when the membrane switch circuit is pressed down; and
a lower circuit board, located under the insulating layer, having at least one lower contact corresponding to the at least one upper contact, and the at least one upper contact and the at least one lower contact forming at least one key contact, wherein the at least one lower contact is capable of contacting with the at least one upper contact and thus generating a signal when the membrane switch circuit is pressed down.

In a preferred embodiment, at least one of the upper circuit board, the insulating layer and the lower circuit board is made of a light guide material, and at least one of the upper circuit board, the insulating layer and the lower circuit board has a plurality of light guide structure and is capable of guiding the at least one light beam, so as to enable the membrane switch circuit to guide the at least one light beam to project to the plurality of keys.

In a preferred embodiment, the illuminating keyboard of the present invention further comprises a main circuit board connecting with the membrane switch circuit and capable of providing the electricity to the membrane switch circuit and the light source conducting circuit, and the membrane switch circuit further comprises:
a bus, connected with the main circuit board and capable of transferring the electricity or a plurality of signals corresponding to the plurality of key contacts; and
a conducting circuit, connected with the plurality of key contacts and the bus and capable of transferring the electricity or the plurality of signals corresponding to the plurality of key contacts, wherein the conducting circuit and the bus are arranged on any one of the upper circuit board, the insulating layer and the lower circuit board.

In a preferred embodiment, the illuminating keyboard of the present invention further comprises a bottom plate capable of carrying the plurality of keys, and each one of the keys comprises:
a key cap, exposed by an upper surface of the illuminating keyboard, and the key cap having a light transmissive region;
a scissor connection component, located between the bottom plate and the key cap and capable of connecting the bottom plate and the key cap for enabling the key cap to move up and down relative to the base plate; and
an elastomer, located between the membrane switch circuit and the key cap, wherein the elastomer is compressed to lean against the membrane switch circuit when the key cap is pressed down, so as to activate the corresponding one of the key contacts, while the elastomer provides an elastic force to the key cap when the key cap is no longer pressed down, so as to return the key cap.

In a preferred embodiment, the illuminating keyboard of the present invention further comprises a base capable of carrying the plurality of keys, and each one of the keys comprises:
a key cap, exposed by an upper surface of the illuminating keyboard, and the key cap having a light transmissive region;
a key housing, located between the base and the key cap and capable of carrying the key cap; and
an elastomer, passing through the key housing and located between the membrane switch circuit and the key cap, wherein the elastomer is compressed to lean against the membrane switch circuit when the key cap is pressed down, so as to activate the corresponding one of the key contacts, while the elastomer provides an elastic force to the key cap when the key cap is no longer pressed down, so as to return the key cap.

In a preferred embodiment, the at least one light source is a lateral light emitting diode (LED).

### BRIEF DESCRIPTION OF THE DRAWINGS

FIG. 1 illustrates an external structural view of a conventional keyboard.

FIG. 2 illustrates a structural cross-sectional view of a conventional illuminating keyboard.

FIG. 3 illustrates a structural side view of an illuminating keyboard according to a first preferred embodiment of the present invention.

FIG. 4 illustrates a structural explosion view of a membrane switch circuit and a reflector plate of the illuminating keyboard according to the first preferred embodiment of the present invention.

FIG. 5 illustrates a structural top view of a lower circuit board of the illuminating keyboard according to the first preferred embodiment of the present invention.

FIG. 6 illustrates a structural side view of an illuminating keyboard according to a second preferred embodiment of the present invention.

FIG. 7 illustrates a structural explosion view of a membrane switch circuit and a reflector plate of the illuminating keyboard according to the second preferred embodiment of the present invention.

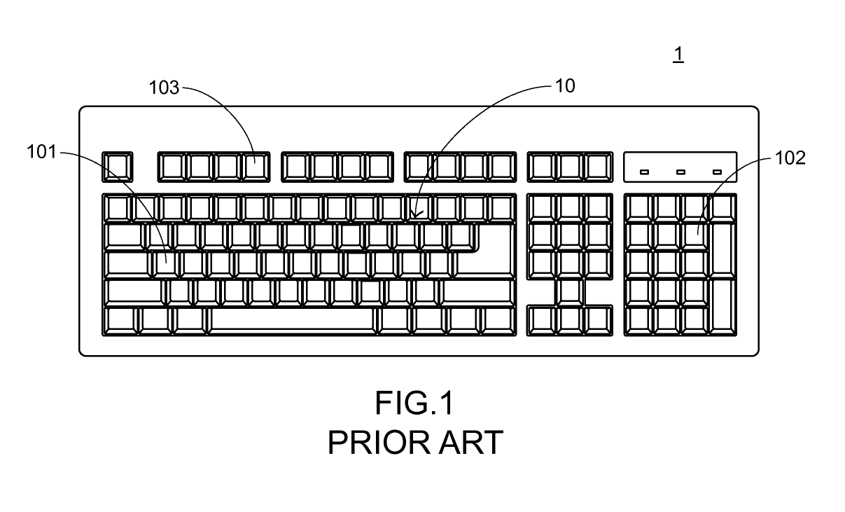

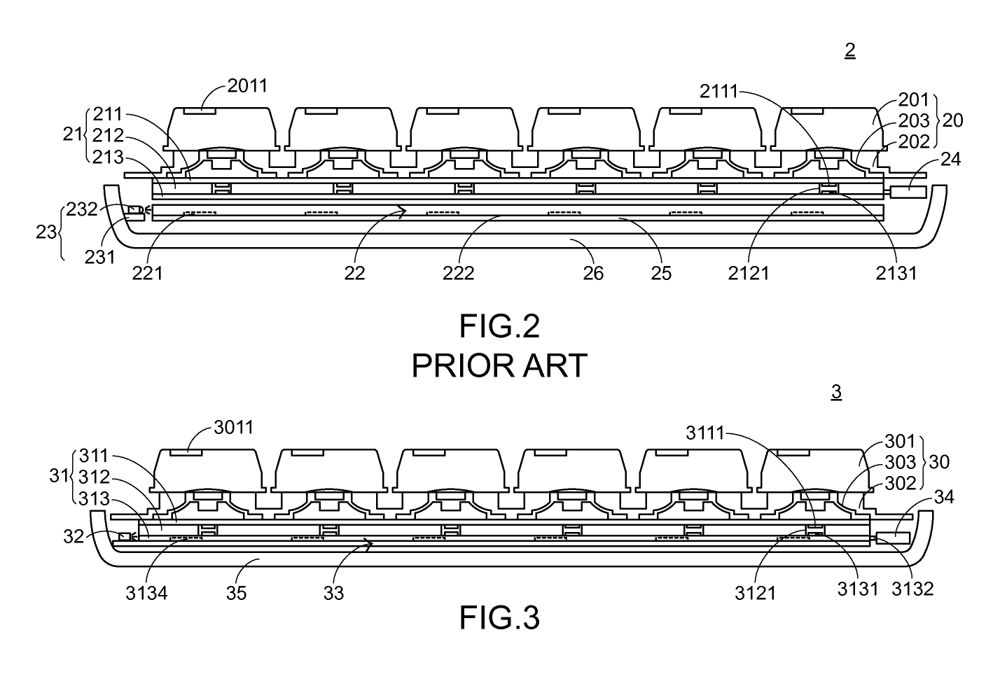

### DETAILED DESCRIPTION OF THE PREFERRED EMBODIMENT

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations are not described in detail in order not to obscure the present invention.

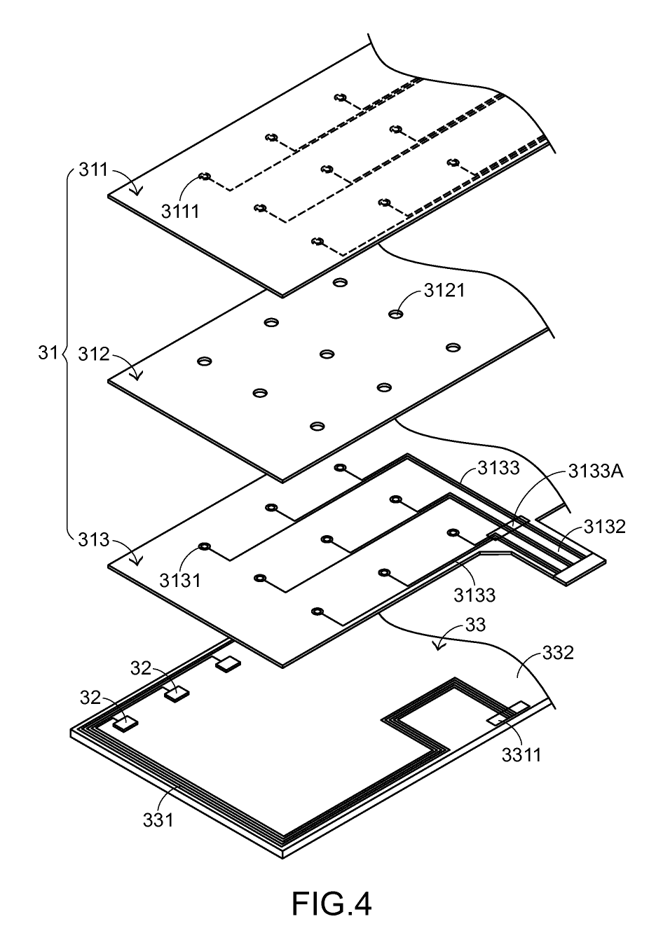

In view of the defects of the conventional arts, the present invention provides a kind of illuminating keyboard. FIG. 3 illustrates a structural side view of an illuminating keyboard according to a first preferred embodiment of the present invention. Referring to FIG. 3, the illuminating keyboard 3 comprises a plurality of keys 30, a membrane switch circuit 31, a plurality of light sources 32 (referring to FIG. 4), a reflector plate 33, a main circuit board 34 and a base 35. Each one of the keys 30 comprises a key cap 301, a key housing 302 and an elastomer 303. An arranging sequence of the foregoing components in the illuminating keyboard 3 from top to bottom is the key caps 301, the key housings 302, the elastomers 303, the membrane switch circuit 31, the light sources 32, the reflector plate 33 and the base 35. The plurality of light sources 32 are arranged on the reflector plate 33 and located at a side of the membrane switch circuit 31, while the main circuit board 34 is located at an another side of the membrane switch circuit 31 and capable of providing an electricity. In the present preferred embodiment, the illuminating keyboard 3 is a keyboard for a desktop personal computer (PC), and the side of the membrane switch circuit 31 is the lower side of the membrane switch circuit 31 (i.e. the side with the space key), while the another side of the membrane switch circuit 31 is the upper side of the membrane switch circuit 31 (i.e. the side with the function key F1).

In each one of the keys 30, the key cap 301 is exposed by an upper surface of the illuminating keyboard 3 and thus capable of being pressed down by a user, and the key cap 301 has a light transmissive region 3011, i.e. a location of a letter or a symbol. Further, the key housing 302 is capable of holding the key cap 301 and the elastomer 303, while the elastomer 303 passes through the key housing 302 and respectively contacts with the key cap 301 and the membrane switch circuit 31. In the present preferred embodiment, the key housing 302 is mode of a light transmissive material, and the elastomer 303 is made of a light transmissive rubber. Moreover, the membrane switch circuit 31 has a plurality of key contacts, and each one of the key contacts corresponds to a key 30. Besides, the membrane switch circuit 31 connects with the main circuit board 34, so as to obtain the electricity coming from the main circuit board 34 or to transfer a signal to the main circuit board 34.

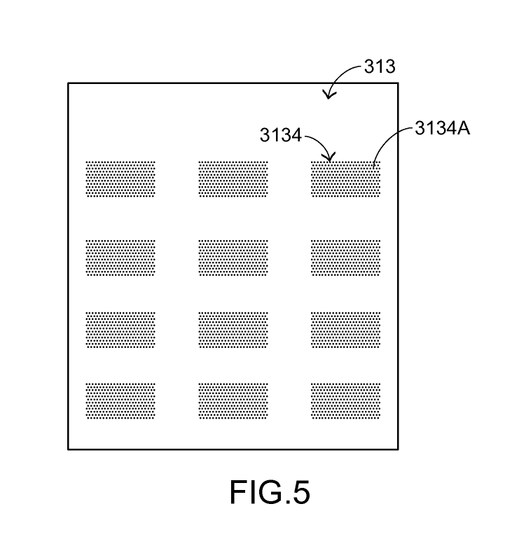

FIG. 4 illustrates a structural explosion view of a membrane switch circuit and a reflector plate of the illuminating keyboard according to the first preferred embodiment of the present invention, while FIG. 5 illustrates a structural top view of a lower circuit board of the illuminating keyboard according to the first preferred embodiment of the present invention. Referring to FIG. 3 and FIG. 4 together, the reflector plate 33 is located under the membrane switch circuit 31. Further, the reflector plate 33 comprises a light source conducting circuit 331 arranged on an upper surface 332 of the reflector plate 33, wherein the light source conducting circuit 331 is capable of transferring an electricity, and the light source conducting circuit 331 includes a first bonding region 3311. The plurality of light sources 32 are arranged on the upper surface 332 of the reflector plate 33, connected with the light source conducting circuit 331 and capable of generating at least one light beam according to the electricity. In the present preferred embodiment, each one of the light sources 32 is a side view light emitting diode (LED), and the reflector plate 33 is made of an opaque polyethylene terephthalate (PET), while the light source conducting circuit 331 is a silver paste line distributed on the upper surface 332 of the reflector plate 33 with a printing technology.

The membrane switch circuit 31 includes an upper circuit board 311, an insulating layer 312 and a lower circuit board 313. Herein, the upper circuit board 311 has a plurality of upper contacts 3111. In addition, the insulating layer 312 is located under the upper circuit board 311 and has a plurality of insulating layer apertures 3121 corresponding to the plurality of upper contacts 3111. In contrast, the lower circuit board 313 is located under the insulating layer 312 and has a plurality of lower contacts 3131 corresponding to the plurality of upper contacts 3111, a bus 3132 and a conducting circuit 3133. Further, the plurality of lower contacts 3131 form a plurality of key contacts with the plurality of upper contacts 3111, and the bus 3132 connects with the main circuit board 34 and capable of transferring the electricity or a plurality of signals corresponding to the plurality of key contacts, while the conducting circuit 3133 connects with the plurality of lower contacts 3131 and the bus 3132 of the plurality of key contacts. In addition, the conducting circuit 3133 has a second bonding region 3133A capable of connecting with the first bonding region 3311 of the light source conducting circuit 331, so as to transfer the electricity coming from the main circuit board 34 to the light source conducting circuit 331. In the present preferred embodiment, both of the upper circuit board 311 and the insulating layer 312 are made of a transparent material but the lower circuit board is made of a light guide material, and the light guide material is polycarbonate (PC), Acrylic (or named polymethyl methacrylate, PMMA), and so on. In addition, the lower circuit board 313 further comprises a plurality of light guide regions 3134 and each one of the light guide regions 3134 is composed of a plurality of light guide structures 3134A. In the present preferred embodiment, as shown in FIG. 5, the plurality of light guide structures 3134A is a plurality of dot patterns. The plurality of dot patterns 3134A are capable of guiding the plurality of light beams, and the arranged locations of the plurality of light guide region 3134 correspond to the plurality of light transmissive regions 3011 on the plurality of keys 30 as shown in FIG. 3. As a result, the plurality of light beams can be guided to pass through the membrane switch circuit 31 by the membrane switch circuit 31 and then projected to the plurality of light transmissive regions 3011 of the plurality of keys 30.

Of course, the plurality of light guide structures of the present invention are not limited to the plurality of dot patterns. In the other preferred embodiments, the plurality of light guide structures can further use micro structures arranged densely, such as micro lenses, V shaped incisions or other micro structures capable of being used for guiding the light.

As illustrated in FIG. 4, the first bonding region 3311 of the light source conducting circuit 331 is aligned to the second bonding region 3133A of the conducting circuit 3133. As the reflector plate 33 is combined with the membrane switch circuit 31, the first boding region 3311 is connected with the second bonding region 3133A, and thus the light source conducting circuit 331 is electrically connected with the conducting circuit 3133, and the conducting circuit 3133 is connected with the bus 3132, while the bus 3132 is connected with the main circuit board 34. As a result, the electricity provided by the main circuit board 34 are enable to be transferred to the plurality of light sources via the bus 3132, the conducting circuit 3133, the second bonding region 3133A, the first bonding region 3311 and the light source conducting circuit 331 in sequence, so as to enable the plurality of light sources 32 to generate the plurality of light beams.

A combination condition between each one of the above mentioned components is illustrated in FIG. 3. In the illuminating keyboard 3, the reflector plate 33 is arranged under the membrane switch circuit 31, and the plurality of light sources 32 are arranged on the upper surface 322 of the reflector plate 33 and located at a side of the membrane switch circuit 31, so that the plurality of light beams generated by the plurality of light sources 32 are enable to be projected to the membrane switch circuit 31 and further guided to pass through the membrane switch circuit 31 by the plurality of light guide regions 3134 in the membrane switch circuit 31. Herein, both of the key housing 302 and the elastomer 303 are capable of being passed through by the light beams, so as to enable the plurality of light beams to pass through the membrane switch circuit 31, the elastomer 303, the key housing 302 and the light transmissive region 3011 in sequence and further display the letter or the symbol on the key cap 301.

An operation condition of any one of the keys 30 being pressed down is illustrated hereinafter. When the key 30 is pressed down and thus moved downward relative to the key housing 302, the key cap 301 moving downward leans against the elastomer 303, so as to lean the elastomer 303 against the membrane switch circuit 31. In the membrane switch circuit 31, the upper contact 3111 inserts into the insulating layer aperture 3121 and contacts with the lower contact 3131, so as to establish an electric conductance between the upper contact 3111 and the lower contact 3131 and thus generate a key signal corresponding to the key 30. In contrast, when the key 30 is no longer pressed down, the elastomer 303 provides an elastic force to the key cap 301, so that the key cap 301 is moved upward relative to the key housing 302 and thus the key cap 30 is returned.

It should be noted that the bus, the conducting circuit and the plurality of light guide structures can not only be arranged on the lower circuit board, but also arranged on the insulating layer of the membrane switch circuit. In such a case, the second bonding region on the conducting circuit is connected to the first bonding region of the light source conducting circuit, so as to establish an electric conductance between the main circuit board and the light source conducting circuit.

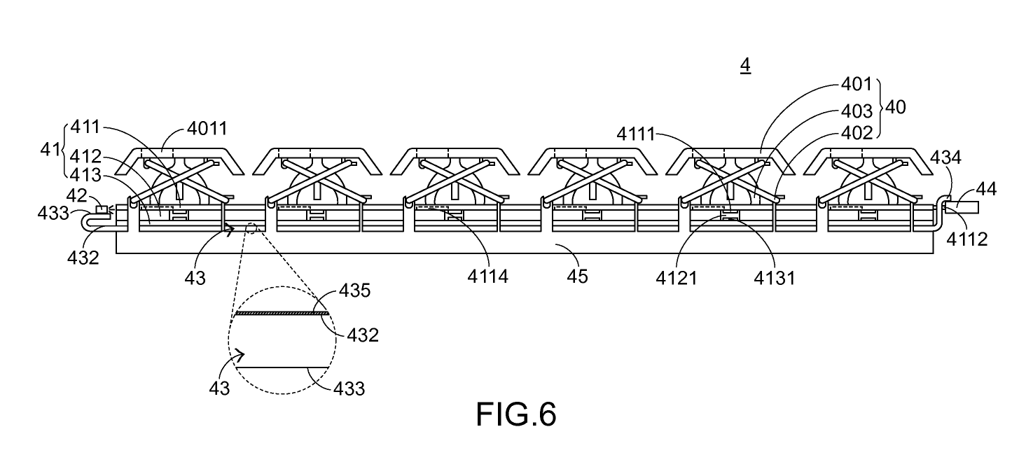

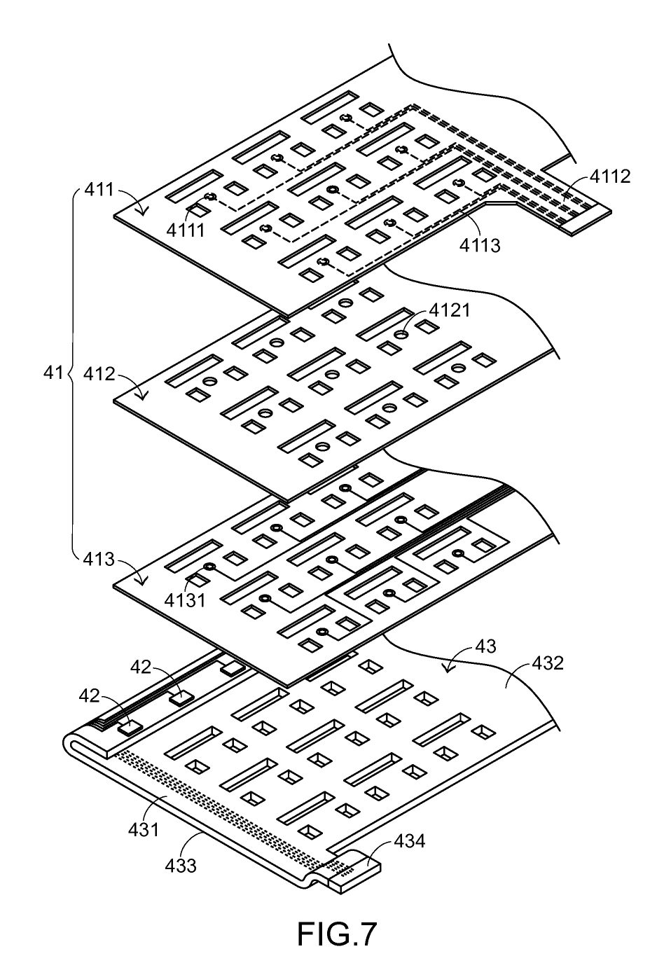

Besides, the present embodiment further provides a second preferred embodiment. FIG. 6 illustrates a structural side view of an illuminating keyboard according to a second preferred embodiment of the present invention. Referring to FIG. 6, the illuminating keyboard 4 comprises a plurality of keys 40, a membrane switch circuit 41, a plurality of light sources 42 (referring to FIG. 7), a reflector plate 43, a main circuit board 44 and a bottom plate 45. Each one of the keys 40 comprises a key cap 401, a scissor connection component 402 and a elastomer 403. An arranging sequence of each one of the foregoing components in the illuminating keyboard 4 from top to bottom is the key cap 401, the scissor connection component 402, the elastomer 403, the membrane switch circuit 41, the light source 42, the reflector plate 43 and the bottom plate 45. The plurality of light sources 42 are arranged on the reflector plate 43 and located at a side of the membrane switch circuit 41, while the main circuit board 44 is located at an another side of the membrane switch circuit 41 and used for providing an electricity. In the present preferred embodiment, the illuminating keyboard 4 is a keyboard used for a notebook personal computer (Notebook PC), and the side of the membrane switch circuit 41 is the lower side of the membrane switch circuit 41 (i.e. the side with the space key), while the another side of the membrane switch circuit 41 is an upper side of the membrane switch circuit 41 (i.e. the side with the function key F1).

In each one of the keys 40, the key cap 401 is exposed by an upper surface of the illuminating keyboard 4 and thus capable of being pressed down by a user, and the key cap 401 has a light transmissive region 4011, i.e. a location of a letter or a symbol. Further, the scissor connection component 402 is capable of holding the key cap 401 and the elastomer 403, while the elastomer 403 passes through the scissor connection component 402 and respectively contacts with the key cap 401 and the membrane switch circuit 41. In the present preferred embodiment, the scissor connection component 402 is mode of a light transmissive material, and the elastomer 403 is made of a light transmissive rubber. Moreover, the membrane switch circuit 41 has a plurality of key contacts, and each one of the key contacts corresponds to a key 40. Besides, the membrane switch circuit 41 connects with the main circuit board 44, so as to obtain the electricity coming from the main circuit board 44 or to transfer a signal to the main circuit board 44.

FIG. 7 illustrates a structural explosion view of a membrane switch circuit and a reflector plate of the illuminating keyboard according to the second preferred embodiment of the present invention. Referring to FIG. 6 and FIG. 7 together, the reflector plate 43 is located under the membrane switch circuit 41. Further, the reflector plate 43 comprises a light source conducting circuit 431 and a reflector plate bus 434. Herein, the light source conducting circuit 431 is arranged on a lower surface 433 of the reflector plate 43 and capable of transferring the electricity. In addition, the reflector plate bus 434 is connected with the light source conducting circuit 431 and the main circuit board 44 and capable of transferring the electricity. Furthermore, the plurality of light sources 42 are arranged on the lower surface 433 of the reflector plate 43, connected with the light source conducting circuit 431 and capable of generating at least one light beam according to the electricity. In the present preferred embodiment, each one of the light sources 42 is a side view light emitting diode (LED), and the light source conducting circuit 431 is a silver paste line distributed on the lower surface 433 of the reflector plate 43 with a printing technology. Moreover, the reflector plate 43 is made of a transparent polyethylene terephthalate (PET), while the transparent reflector plate 43 comprises a reflective ink 435, which is arranged on an upper surface 432 of the reflector plate 43, so as to enable the reflector plate 43 to reflect the plurality of light beams.

As illustrated in FIG. 7, the membrane switch circuit 41 includes an upper circuit board 411, an insulating layer 412 and a lower circuit board 413. Herein, the upper circuit board 411 has a plurality of upper contacts 4111, a bus 4112, a conducting circuit 4113 and a plurality of light guide region 4114 (as illustrated in FIG. 6). In addition, the insulating layer 412 is located under the upper circuit board 411 and has a plurality of insulating layer apertures 4121 corresponding to the plurality of upper contacts 4111. In contrast, the lower circuit board 413 is located under the insulating layer 412 and has a plurality of lower contacts 4131 corresponding to the plurality of upper contacts 4111, and the plurality of lower contacts 4131 form a plurality of key contacts with the plurality of upper contacts 4111.

In the upper circuit board 411, the bus 4112 connects with the main circuit board 44 and capable of transferring the electricity or a plurality of signals corresponding to the plurality of key contacts, while the conducting circuit 4113 connects with the plurality of upper contacts 4111 and the bus 4112 of the plurality of key contacts. As a result, the membrane switch circuit 41 connects with the main circuit board 44 via the bus 4112, so as to transfer the electricity and the signal corresponding to the key contact. In the present preferred embodiment, all of the upper circuit board 411, the insulating layer 412 and the lower circuit board 413 are made of a light guide material, and the light guide material is polycarbonate (PC) and so on. In addition, the plurality of light guide regions 4114 of the upper circuit board 411 are formed from a plurality of light guide structures (not shown in the figures) as well, so as to enable the plurality of light guide regions 4114 to guide the plurality of light beams, and the arrangement locations of a plurality of light guide regions 4114 are corresponding to the plurality of light transmissive regions 4011 on the plurality of keys 40 as illustrated in FIG. 6. As a result, the plurality of light beams can be guided to pass through the membrane switch circuit 41 and the light transmissive elastomer 403 by the membrane switch circuit 41 and then projected to the plurality of light transmissive regions 4011 of the plurality of keys 40.

As illustrated in FIG. 7, the reflector plate 43 is connected with the main circuit board 44 via the reflector plate bus 434 (as illustrated in FIG. 6), and the reflector plate bus 434 is arranged with a bended manner, so as to enable the light source conducting circuit 431 located on the lower surface 433 of the reflector plate 43 to connect with the main circuit board 44 as illustrated in FIG. 6. As a result, the electricity provided by the main circuit board 44 is capable of being transferred to the plurality of light sources 42 by the reflector plate bus 414 and the light source conducting circuit 431, so as to enable the plurality of light sources 42 to generate the plurality of light beams.

A combination condition between each one of the above mentioned components is illustrated in FIG. 7. In the illuminating keyboard 4, the reflector plate 43 is arranged under the membrane switch circuit 41, and the plurality of light sources 42 are arranged on the lower surface 433 of the reflector plate 43, wherein the reflector plate 43 is arranged with a bended manner, so as to enable the plurality of light sources 42 to locate at a side of the membrane switch circuit 41. As a result, the plurality of light beams generated by the plurality of light sources 42 are enable to be projected to the membrane switch circuit 41 and further guided to pass through the membrane switch circuit 41 by the plurality of light guide regions 4114 in the membrane switch circuit 41, so as to enable the plurality of light beams to pass through the membrane switch circuit 41, the elastomer 403 and the light transmissive region 4011 in sequence and then to display the letter or the symbol on the key cap 401.

Similar to the first preferred embodiment, when any one of the keys 40 is pressed down and thus moved downward relative to the bottom plate 45, the scissor connection component 402 is switched from an extension state into a compression state in response to the movement of the key cap 401 and the key cap 401 moving downward leans against the elastomer 403, so as to lean the elastomer 403 against the membrane switch circuit 31. In the membrane switch circuit 41, the upper contact 4111 inserts into the insulating layer aperture 4121 and contacts with the lower contact 4131, so as to establish an electric conductance between the upper contact 4111 and the lower contact 4131 and thus generate a key signal corresponding to the key 40. In contrast, when the key 40 is no longer pressed down, the elastomer 403 provides an elastic force to the key cap 401, so that the key cap 401 is moved upward relative to the bottom plate 45 and the scissor connection component 402 is switched from the compression state into the extension state in response to the movement of the key cap 401, and thus the key cap 40 is returned.

It should be noted that, in the present invention, neither the light sources are limited to be arranged at the one side of the membrane switch circuit, nor the main circuit board is limited to be arranged at the other one side of the membrane switch circuit. In another word, the light sources can also be arranged at the other one side of the membrane switch circuit, while the main circuit board can also be arranged at the one side of the membrane switch circuit. Of course, both of the light sources and the main circuit board are able to be arranged at the one side of the membrane switch circuit or the other one side of the membrane switch circuit at the same time.

According to the two above mentioned preferred embodiments, it is understood that the illuminating keyboard of the present invention is to arrange the light sources on the reflector plate, and the reflector plate is arranged with the light source conducting circuit thereon and thus connected with the main circuit board, so as to enable the light sources to obtain the electricity coming from the main circuit board and thus to generate the light beams. In addition, the light source conducting circuit is the silver paste line formed with a printing technology. As a result, the assembly procedure of the illuminating keyboard is able to be simplified since the electrical connections between the light sources and the main circuit board are unnecessary to use the conventional physical circuit layout. Also, the light sources are arranged on the reflector plate instead of arranged by the conventional illuminating circuit board, so as to prevent the conventional illuminating circuit board from that the wrapped or the uneven assembly issue is likely to occur. Hence, the illumination result provided by the illuminating keyboard of the present invention is more uniform. In addition, a cost of the illuminating keyboard of the present invention is able to be reduced as well since it is unnecessary to arrange the illuminating circuit board in the illuminating keyboard of the present invention.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. An illuminating keyboard, comprising:
a plurality of keys;
a membrane switch circuit, having a plurality of key contacts, and each one of the key contacts corresponding to one of the keys;
a reflector plate, located under the membrane switch circuit, and the reflector plate comprising a light source conducting circuit, wherein the light source conducting circuit is capable of transferring an electricity; and
at least one light source, arranged on the reflector plate, connected with the light source conducting circuit, and capable of generating at least one light beam according to the electricity.

2. The illuminating keyboard as claimed in claim 1, wherein the light source conducting circuit is arranged on an upper surface or a lower surface of the reflector plate, while the at least one light source is arranged on the upper surface or the lower surface of the reflector plate and located at a side of the membrane switch circuit.

3. The illuminating keyboard as claimed in claim 1, wherein the reflector plate is made of an opaque polyethylene terephthalate (PET).

4. The illuminating keyboard as claimed in claim 1, wherein the reflector plate further comprises a reflective ink arranged on an upper surface of the reflector plate, so as to enable the reflector plate to reflect the at least one light beam, and the reflector plate is made of a transparent PET.

5. The illuminating keyboard as claimed in claim 1, further comprising a main circuit board connected with the membrane switch circuit and capable of providing the electricity to the membrane switch circuit and the light source conducting circuit.

6. The illuminating keyboard as claimed in claim 5, wherein the light source conducting circuit further comprises a first bonding region, while the membrane switch circuit comprises:
a bus, connected with the main circuit board and capable of transferring the electricity or a plurality of signals corresponding to the plurality of key contacts; and
a conducting circuit, connected with the plurality of key contacts and the bus, and the conducting circuit has a second bonding region capable of connecting with the first bonding region of the light source conducting circuit and transferring the electricity coming from the main circuit board to the light source conducting circuit.

7. The illuminating keyboard as claimed in claim 5, wherein the reflector plate further comprises a reflector plate bus, a first end of the reflector plate bus is connected with the light source conducting circuit, and a second end of the reflector plate bus is connected with the main circuit board and capable of transferring the electricity coming from the main circuit board to the light source conducting circuit.

8. The illuminating keyboard as claimed in claim 1, wherein the membrane switch circuit further comprises:
an upper circuit board, having at least one contact;
an insulating layer, located under the upper circuit board, the insulating layer having at least one insulating layer aperture corresponding to the at least one upper contact, and the at least one upper contact capable of inserting into the at least one insulating layer aperture when the membrane switch circuit is pressed down; and
a lower circuit board, located under the insulating layer, having at least one lower contact corresponding to the at least one upper contact, and the at least one upper contact and the at least one lower contact forming at least one key contact, wherein the at least one lower contact is capable of contacting with the at least one upper contact and thus generating a signal when the membrane switch circuit is pressed down.

9. The illuminating keyboard as claimed in claim 8, wherein at least one of the upper circuit board, the insulating layer and the lower circuit board is made of a light guide material, and at least one of the upper circuit board, the insulating layer and the lower circuit board has a plurality of light guide structure and is capable of guiding the at least one light beam, so as to enable the membrane switch circuit to guide the at least one light beam to project to the plurality of keys.

10. The illuminating keyboard as claimed in claim 8, further comprising a main circuit board connecting with the membrane switch circuit and capable of providing the electricity to the membrane switch circuit and the light source conducting circuit, and the membrane switch circuit further comprising:
a bus, connected with the main circuit board and capable of transferring the electricity or a plurality of signals corresponding to the plurality of key contacts; and
a conducting circuit, connected with the plurality of key contacts and the bus and capable of transferring the electricity or the plurality of signals corresponding to the plurality of key contacts, wherein the conducting circuit and the bus are arranged on any one of the upper circuit board, the insulating layer and the lower circuit board.

11. The illuminating keyboard as claimed in claim 1, further comprising a bottom plate capable of carrying the plurality of keys, and each one of the keys comprising:
a key cap, exposed by an upper surface of the illuminating keyboard, and the key cap having a light transmissive region;
a scissor connection component, located between the bottom plate and the key cap and capable of connecting the bottom plate and the key cap for enabling the key cap to move up and down relative to the base plate; and
an elastomer, located between the membrane switch circuit and the key cap, wherein the elastomer is compressed to lean against the membrane switch circuit when the key cap is pressed down, so as to activate the corresponding one of the key contacts, while the elastomer provides an elastic force to the key cap when the key cap is no longer pressed down, so as to return the key cap.

12. The illuminating keyboard as claimed in claim 1, further comprising a base capable of carrying the plurality of keys, and each one of the keys comprising:
a key cap, exposed by an upper surface of the illuminating keyboard, and the key cap having a light transmissive region;
a key housing, located between the base and the key cap and capable of carrying the key cap; and
an elastomer, passing through the key housing and located between the membrane switch circuit and the key cap, wherein the elastomer is compressed to lean against the membrane switch circuit when the key cap is pressed down, so as to activate the corresponding one of the key contacts, while the elastomer provides an elastic force to the key cap when the key cap is no longer pressed down, so as to return the key cap.

13. The illuminating keyboard as claimed in claim 1, wherein the at least one light source is a lateral light emitting diode (LED).
